(19) United States
(12) Patent Application Publication
(10) Pub. No.: US 2023/0206094 A1
(43) Pub. Date: Jun. 29, 2023

(54) INFERRING DEVICE, INFERRING METHOD AND NON-TRANSITORY COMPUTER READABLE MEDIUM

(71) Applicant: Preferred Networks, Inc., Tokyo (JP)

(72) Inventor: Masashi YOSHIKAWA, Tokyo (JP)

(73) Assignee: Preferred Networks, Inc., Tokyo (JP)

(21) Appl. No.: 18/178,721

(22) Filed: Mar. 6, 2023

Related U.S. Application Data
(63) Continuation of application No. PCT/JP21/32874, filed on Sep. 7, 2021.

(30) Foreign Application Priority Data
Sep. 7, 2020 (JP) 2020-150074

(51) Int. Cl. G06N 5/04

(52) U.S. Cl. CPC G06N 5/04

(57) ABSTRACT

An inferring device includes one or more memories and one or more processors. The one or more processors are configured to input input data including at least information regarding a first state in a differentiable physical model to calculate an inferred second state; and infer, based on a second state and the inferred second state, a parameter that transits from the first state to the second state.

### CROSS REFERENCE TO THE RELATED APPLICATION

This application is continuation application of International Application No. JP2021/032874, filed on Sep. 7, 2021, which claims priority to Japanese Patent Application No. 2020-150074, filed on Sep. 7, 2020, the entire contents of which are incorporated herein by reference.

### FIELD

The present disclosure relates to an inferring device, an inferring method, and a non-transitory computer readable medium.

### BACKGROUND

Nowadays, there are simulators of various physical phenomena for various purposes. Each of these simulators includes a certain type of model, and performs a simulation of physical phenomenon, behavior when performing control, and so on, based on input/output of the model. However, the model itself is not differentiable in some cases. In such a case, when a slightly different parameter is input in the model, it is difficult to acquire an accurate result. According to an example of using a neural network model capable of performing backward propagation, it is possible to deal with the change in parameter as described above, but it is difficult to say that a result thereof is a control value in conformity to the physical law.

### BRIEF DESCRIPTION OF DRAWINGS

FIG. 1 is a block diagram illustrating an outline of an inferring device according to an embodiment;

FIG. 2 is a flow chart illustrating processing of the inferring device according to the embodiment; and

FIG. 3 is an example of a hardware implementation of one embodiment.

### DETAILED DESCRIPTION

According to one embodiment, an inferring device includes one or more memories and one or more processors. The one or more processors are configured to input input data including at least information regarding a first state in a differentiable physical model to calculate an inferred second state; and infer, based on a second state and the inferred second state, a parameter that transits from the first state to the second state.

Hereinafter, embodiments of the present invention will be explained with reference to the drawings. The explanations of the drawings and the embodiments are presented by way of example only, and are not intended to limit the present invention. Hereinafter, a plant is sometimes described as an example, but it is described as an example only, and the description does not limit the contents of the present disclosure.

Note that although terms initial state (first state) and final state (second state) are used in the present disclosure, the terms may mean an initial stage and a final stage of a state to be a target of arithmetic operation. The initial state and the final state may indicate a state at a timing of starting observation of a focused physical phenomenon or the like and a state at a timing of terminating the observation, respectively, or they may also indicate other states. They may also mean, in a transition state of the physical phenomenon or the like, an initial state and a final state at a focused time. Specifically, the initial state and the final state may also mean the first state and the last state in a period to be a target of arithmetic operation. The first state and the last state may also be set to states at arbitrary two timings when the state transits temporally, for example, from the first to the last. It should be noted that when the term final state is described in the explanation hereinbelow, it can be read as an input second state, or it can also be read as an inferred second state calculated through forward propagation, based on the context, unless otherwise noted.

(Inferring Device)

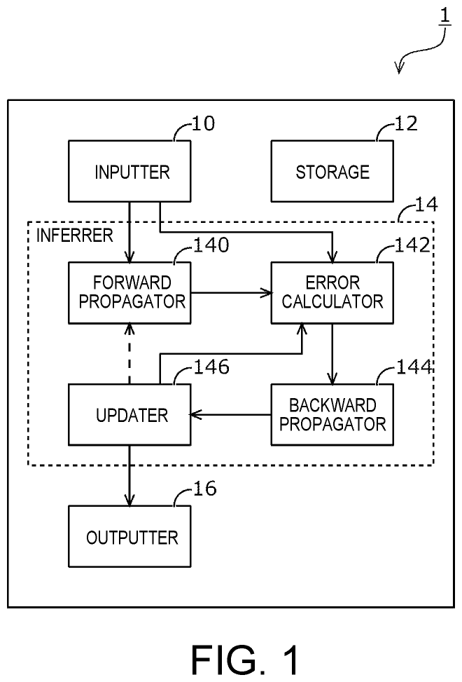

FIG. 1 is a block diagram illustrating an outline of an inferring device according to an embodiment. An inferring device 1 includes an inputter 10, a storage 12, an inferrer 14, and an outputter 16. When, for example, a current state and a parameter are input in this inferring device 1, the device infers and outputs a future state.

The state indicates, as an example, a state of a device to be a control target. As a more concrete example, when an inference target is a plant, the state may be an amount of substance that exists inside a certain device of the plant, or an amount including information regarding internal energy or the like of the substance.

The parameter is, as an example, a value regarding control that is input in a device or the like to be a control target (referred to as a control value, hereinbelow), a value regarding environment, or the like. For example, in the inferring device 1 regarding the plant, the control value is a value regarding at least one of a temperature, a humidity, a pressure, a voltage, a current, a substance concentration, or the like capable of being controlled. The parameter may also be time-series data, for example. Specifically, the parameter is all or a part of values capable of being controlled by a user, out of values which may exert some kind of influence on a physical phenomenon in a system to be an inference target, for example. The parameter is not limited to one regarding the control, and it is only required to be a value which may exert an influence on a system to be inferred.

The value regarding environment may include, as an example, information regarding a device to be a control target. More concretely, the value regarding environment may include information regarding a volume, a capacity, or a shape of the device to be the control target.

The inputter 10 accepts input of various pieces of information. For example, in the inferring device 1, data regarding a current state, and a parameter are input via the inputter 10. Further, separately from this, a state and a parameter may be input, as data that can be supervised data, in the inferring device 1 via the inputter 10. For example, when it is wanted to infer, in a case where a desirable state is already known, what kind of parameter is input from an initial state to achieve the desirable state, an initial value of the parameter is input via the inputter 10. The initial value of the parameter may be time-series data as described above, and in this case, initial data of the parameter is input via the inputter 10.

The storage 12 temporarily stores input data and the like, for example. The storage 12 may also store, other than the above, data regarding a model that is used for inference. When the inferring device 1 concretely realizes software processing by hardware, the storage 12 may also store a program, an executable file, and so on of the software. Further, the storage 12 may also store an inference result.

The inferrer 14 includes a forward propagator 140, an error calculator 142, a backward propagator 144, and an updater 146. The inferrer 14 uses a physical model, to thereby output an inference result from input data. The inferrer 14 inputs a state at a certain time point and a parameter from the certain time point in a physical model, to thereby infer a future state, for example. The physical model is a model that solves a physical equation based on a physical phenomenon, and a model generated in a differentiable manner. Further, based on the future state inferred as above, the inferrer 14 infers and outputs a parameter that realizes the desirable state, for example.

The forward propagator 140 executes forward propagation processing in the physical model. Here, the forward propagation processing is, for example, processing of determining a numerical solution of a differential equation in a forward direction along time. More concretely, the forward propagator 140 successively acquires a state for each step (time point) from an initial value and a parameter based on a given differential equation of physical system. The forward propagator 140 inputs a state and a control value (parameter) in the physical model, and outputs a result indicating how the state transits when executing control designated to the control value, for example. Note that depending on the physical model, the forward propagator 140 may be one that outputs only a final state (final state: second state) based on the differential equation. The processing in the forward propagator 140 may include a case where a numerical expression represented by the physical model is an algebraic equation or a differential algebraic equation. For example, the forward propagation processing in a case of algebraic equation is processing in which, when a certain control value, a geometrical structure of a target device, or the like is input as a parameter without performing timed transition, a state realized as a steady state is acquired. For example, the forward propagation processing in a case of differential algebraic equation is processing in which a numerical solution of the differential algebraic equation is determined in a forward direction along time.

The error calculator 142 calculates an error regarding the state output by the forward propagator 140. The error is calculated by comparing the final state input via the inputter 10 and the final state output by the forward propagator 140, for example. Further, when performing a repetitive arithmetic operation, the error calculator 142 calculates an error by comparing a state input via the inputter 10 and a state based on a parameter updated through backward propagation at the same time point.

The backward propagator 144 executes backward propagation processing in the physical model. Here, the backward propagation processing is processing of determining a differential of error with respect to an initial state and a parameter in reverse chronological order, in a case of a differential equation and a differential algebraic equation, for example. More concretely, based on the error calculated by the error calculator 142, the backward propagator 144 acquires various values in reverse chronological order from at least the final state output by the forward propagator 140. The backward propagator 144 inputs an initial state and a control value in a physical model, and outputs a result indicating what kind of state is created when the parameter is slightly changed, for example. This backward propagation processing is executed when the error calculator 142 determines a gradient from a state by using a physical model being differentiable or capable of calculating a gradient at a required time point.

The updater 146 updates the parameter based on the result of backward propagation performed by the backward propagator 144. The updater 146 updates, based on the differential of the error by the parameter output from the backward propagator 144, the parameter to a more optimum parameter, and outputs the updated parameter as an inference, for example. Note that when required, the updater 146 may continue the backward propagation after updating the control value. Further, as another example, the updater 146 may repeat the processing from the forward propagation.

The outputter 16 outputs the result inferred by the inferrer 14. The outputter 16 may output the inference result to a user via a user interface, or it may also output data to an external file server or the like via an output interface. Further, the outputter 16 may store the data in the storage 12. The output is set to include not only the external output but also the internal output, as described above.

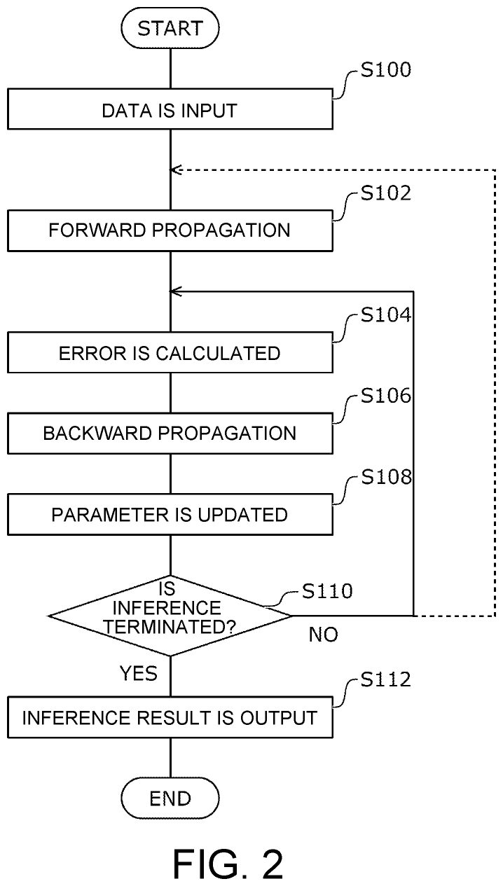

FIG. 2 is a flow chart illustrating processing of the inferring device 1 according to the present embodiment. By using this flow chart, a flow of processing of the inferring device 1 will be described.

(In Case of Algebraic Equation)

First, data to be required is input in the inferring device 1 via the inputter 10 (S100). The data to be required is, for example, data regarding a parameter. The parameter may be an amount regarding the device, for example.

Next, the forward propagator 140 executes the forward propagation processing by using the input data based on the physical model (S102). The forward propagator 140 calculates a state satisfying the algebraic equation when the parameter is given, for example. The algebraic equation is represented by the following equation, for example.

f(x;θ)=0 (eq. 1)

Here, it is set that f is a function representing a physical system, x is a state, and θ is a parameter. As represented in the equation (1), f can be represented by the function in which the state x and the parameter θ are set to variables. The state x and the parameter θ are represented by vectors, for example. This algebraic equation may be a linear one or a nonlinear one.

The forward propagator 140 calculates a transition of state by using a physical model (algebraic equation solver) based on the equation (1). The algebraic equation solver acquires a state satisfying or approximately satisfying the equation (1) through repetitive calculation, for example. The forward propagator 140 acquires a state based on the input parameter. The forward propagator 140 stores necessary values in the storage 12 based on various methods used for backward propagation.

Next, the error calculator 142 compares the state calculated by the forward propagator 140 and the input state, to thereby calculate an error (S104). The error calculator 142 compares, for example, the final state (inferred second state) calculated by the forward propagator 140 and the input actual final state (second state), to thereby calculate an error (loss L) as follows.

L(x(t))=mean((y(t)−x(t))²) (eq. 2)

Here, y is a value of the input state, and mean( ) indicates an average value of components of the state. According to a square error as represented by the equation (2), it becomes possible to acquire a value of dL/dθ, as will be describe later, and it is possible to reduce the error with respect to the given θ, by updating θ. The error (loss) can be calculated by not only this function but also one capable of acquiring a gradient with respect to θ, such as a suitable norm, for example.

Next, the backward propagator 144 performs backward propagation of the error calculated by the error calculator 142 (S106). By propagating the error in a reverse direction in reverse chronological order, it becomes possible to execute the update of the parameter.

Next, the updater 146 updates the parameter θ based on the backward-propagated error (S108). For example, dL/dθ is calculated based on the equation (2) to acquire a gradient of L with respect to θ, and the parameter θ is updated based on θ−εdL/dθ or the like.

Next, the inferring device 1 judges whether or not the inference is terminated (S110). This judgment may be made such that, for example, a desirable final state is previously designated to θ to be updated, and the inference processing is terminated at a timing at which the error becomes smaller than a predetermined threshold value. As another example, it is also possible that the outputter 16 outputs a state to a user via a user interface, and the user selects whether or not the inference is terminated by observing the output. Further, it is also possible to perform output after repeating forward propagation and backward propagation a predetermined number of times. As described above, the termination condition of the inference can be arbitrarily defined.

When it is judged that the inference is not terminated (S110: NO), the processing from S104 is repeated. Further, as another example, the processing from S102 may be repeated.

The processing up to S108 is repeated until when the termination condition of the inference is satisfied in S110. When it is judged that the inference is terminated (S110: YES), the outputter 16 outputs the inference result, and the inferring device 1 terminates the processing. When the parameter is changed, the outputter 16 may output an acquired parameter together with the inferred state, for example. As described above, the inferring device 1 can infer the state, and at the same time, it can optimize the desirable parameter by using a square error or the like, for example. When the physical model can infer an accurate state, the inference of the parameter can also be executed with good accuracy.

As described above, by generating the physical model of inferring the state of the system represented by the algebraic equation in a differentiable manner by the parameter, also when the parameter is changed, for example, it becomes possible to acquire the inference value, namely, it becomes possible to optimize the parameter. As a result of this, it becomes possible to execute the inference with accurate parameter and good accuracy in conformity to the physical law.

(Physical Model of Algebraic Equation)

Next, the physical model of the algebraic equation and a differential method thereof will be described.

As described above, since the physical model in the present embodiment is differentiable, it acquires the inference value of the parameter θ when the state x is given. When the state x is set to a vector, the algebraic equation satisfied by the state x is as represented in the equation (1), for example.

With respect to this, a solver (physical model) of the algebraic equation is defined to determine the state x satisfying the equation (1). Note that the solver also includes one that approximately determines the state x.

When the algebraic equation solver is made to be differentiable, this means that it is made to be differentiable by the parameter θ input in this physical model, for example. Specifically, the physical model is generated so that the state x determined to satisfy the equation (1) is differentiable by θ. A method of making the physical model represented as above to be differentiable, will be described by citing an example.

For the generation of physical model, namely, a numerical calculation of the algebraic equation, some methods such as, for example, the Newton method and the damped Newton method may be used. For example, when the Newton method is used, the physical model is a model that calculates a state based on the following update equation.

$$x ← x - {( \frac{df}{dx} )}^{- 1} f ( x , θ ) \qquad ( eq . 3 )$$

Here, df/dx is a Jacobian matrix. When using this physical model, the forward propagator 140 stores a finally acquired state in the storage 12.

In the backward propagation, a method of Deep Equilibrium Model may be used. According to this method, a calculation of differential used in the backward propagation is executed based on the equation (1).

$$\frac{dx}{d θ} = - {\frac{\partial f}{\partial x}}^{- 1} \frac{\partial f}{\partial θ} \qquad ( eq . 4 )$$

Here, ∂f/∂x and ∂f/∂θ are Jacobian matrices. By using this differential, it becomes possible to conclusively determine dL/dθ.

(In Case of Differential Equation and Differential Algebraic Equation)

First, data to be required is input in the inferring device 1 via the inputter 10 (S100). The data to be required is, for example, data regarding a state and a parameter. The state includes at least an initial state, for example. Further, as the state, actual observation data including at least a final state may be input, and this is used for optimization. The parameter may be time-series data, for example. As an example, a randomly-decided parameter may be input. Hereinafter, attention is focused on time points from t0 to t1, in which a state x(t0) at the time point t0 is set to an initial state, and a state x(t1) at the time point t1 is set to a final state.

Next, the forward propagator 140 executes the forward propagation processing by using the input data based on the physical model (S102). The forward propagator 140 performs successive calculation regarding how a state transits when the time-series parameter is given to the state, for example. When the parameter is time-series data, the forward propagator 140 calculates a numerical solution regarding a state that constantly transits according to the parameter, based on a physical model. For example, in a case of differential equation, the forward propagator 140 calculates a numerical solution based on a differential equation represented by the following equation.

$$\frac{dx ( t )}{dt} = f ( x ( t ) ; θ ( t ) , t ) \qquad ( eq . 5 )$$

Here, f is set to a function representing a physical system, x is set to a state, and θ is set to a parameter. As represented in the equation (1), f can be represented by a function in which the state x and the parameter θ are set to variables. The state x is represented by a vector, for example. This differential equation may be a linear one or a nonlinear one.

For example, in a case of differential algebraic equation, the forward propagator 140 calculates a numerical solution based on a differential algebraic equation represented by the following equation.

f(x(t),\dot{x}(t),θ(t),t)=0 (eq. 6)

Here, f is set to a function representing a physical system, x is set to a state, x-dot is set to a time differential of state (=dx/dt), and θ is set to a parameter. As represented in the equation (6), f becomes 0 when the state x, the time differential of state x-dot, and the parameter θ satisfy the relationship. The state x is represented by a vector, for example. This differential equation may be a linear one or a nonlinear one.

The forward propagator 140 calculates a transition of the state by using the physical model (a differential equation solver or a differential algebraic equation solver) based on the equation (5) or the equation (6). The differential equation solver or the differential algebraic equation solver calculates an integral value through numerical calculation by using a differential coefficient at each time point in accordance with the above equation, to thereby acquire the state x, for example. The forward propagator 140 performs forward propagation of the physical model by using, for example, the input time series of parameter and the input initial state, to thereby acquire a final state (inferred second state) based on the input parameter and initial state (first state). The forward propagator 140 stores necessary values in the storage 12, based on various methods used for backward propagation.

Next, the error calculator 142 compares the state calculated by the forward propagator 140 (inferred second state) and the input state (second state), to thereby calculate an error (S104). The error calculator 142 compares, for example, the final state (inferred second state) calculated by the forward propagator 140 and the input actual final state (second state), to thereby calculate an error (loss L) by the above-described equation (2). The concrete calculation method is the same as that of the above-described algebraic equation. Also in this case, the error (loss) can be calculated by not only this function but also one capable of acquiring a gradient with respect to θ, such as a suitable norm, for example, as a matter of course.

Next, the backward propagator 144 performs backward propagation of the error calculated by the error calculator 142 (S106). By propagating the error in a reverse direction in reverse chronological order, it becomes possible to execute the update of the parameter at an arbitrary time point during the time points t0 to t1.

The processing from S108 to S110 is also the same as that of the above-described algebraic equation.

As described above, by generating the physical model of inferring the state of the system represented by the differential equation or the differential algebraic equation regarding time in a differentiable manner by the parameter, also when the parameter is changed, for example, it becomes possible to acquire the inference value, namely, it becomes possible to optimize the parameter. As a result of this, it becomes possible to execute the inference with accurate parameter and good accuracy in conformity to the physical law.

(Physical Model of Differential Equation or Differential Algebraic Equation)

Next, the physical model will be described. A case of differential equation will be described hereinbelow, but also in a case of differential algebraic equation, the same differential calculation method may be used.

As described above, since the physical model in the present embodiment is differentiable, it acquires the inference value of the parameter θ when the state x is given. When the state x is set to a vector, the differential equation satisfied by the state x is as represented in the equation (1), for example.

With respect to this, a solver (physical model) of the differential equation at the time points t0 to t1 can be defined to execute the following integration.

x(t1;θ)=∫ₜ₀^{t1}f(x(t);θ(t),t)dt+x(t0) (eq. 7)

When this equation (7) is made to be differentiable, this means that the integration result x(t1;θ) is made be differentiable by the parameter θ and the initial state x(t0) input in this physical model, for example. Specifically, the physical model is generated so that the equation (7) is differentiable by θ. A method of making the physical model represented as above to be differentiable, will be described by citing some examples.

### First Example

For the generation of physical model, some methods such as, for example, the Euler method, the midpoint method, and the Runge-Kutta method may be used. When the Euler method is used, for example, the physical model is a model that calculates a state based on the following equation.

x(t+Δt)=x(t)+Δt·f(x(t);θ,t) (eq. 8)

When this physical model is used, the forward propagator 140 stores, regarding a state successively acquired with respect to a time point, data obtained in the middle of arithmetic operation (intermediate data included in a calculation graph) and a state at each time point, in the storage 12. Based on the data stored in the storage 12, it is possible to acquire gradients (differential values) regarding the state x(t) and the parameter θ at each time point based on an equation (9) and an equation (10).

$$\begin{matrix}\frac{\partial L}{\partial x ( t )} = \frac{\partial L}{\partial x ( t + Δ t )} \frac{\partial x ( t + Δ t )}{\partial x ( t )} = \frac{\partial L}{\partial x ( t + Δ t )} ( I + Δ t \frac{\partial f ( x ( t ) ; θ , t )}{\partial x ( t )} ) & ( eq . 9 ) \\ {( \frac{\partial L}{\partial θ} )}_{t} = {( \frac{\partial L}{\partial θ} )}_{t + Δ t} + \frac{\partial L}{\partial x ( t + Δ t )} \frac{\partial x ( t + Δ t )}{\partial θ} = {( \frac{\partial L}{\partial θ} )}_{t + Δ t} + Δ t \frac{\partial L}{\partial x ( t + Δ t )} \frac{\partial f ( x ( t ) ; θ , t )}{\partial θ} & ( eq . 10 )\end{matrix}$$

In the equations, it is possible to successively acquire the respective gradients with respect to the time points in a direction reverse to that of the forward propagation. The gradients regarding x(t) and θ at the time point t can be determined by acquiring the gradients regarding x(t) and θ at a time point t+Δt.

It is possible to acquire df/dx by a value stored in the storage 12. Besides, when it is assumed that the loss function depends only on the final state, for example, it is possible to calculate ∂L/∂x(t1), and further, by setting (∂L/∂θ)t1 to 0, it becomes possible to successively acquire differential values by the state x(t) and the parameter θ, based on the equation (9) and the equation (10). Specifically, it is possible to acquire the gradients of the loss function L regarding the initial state x(t0) and the parameter θ. As described above, by storing the interim process of the forward propagation in the storage 12, it is possible to make the physical model to be differentiable.

Note that actually, there is a case where the error becomes large or the solution is not converged to a desirable one in the Euler method, but if the above-described method of storing all of the calculation processes in the storage 12 is used, it is possible to similarly execute the calculation also in the Runge-Kutta method or the like.

As described above, by performing error backward propagation of the calculation graph of the differential equation solver, it becomes possible to calculate the gradients of the loss function L regarding the state x and the parameter θ. Note that also when the loss function depends not only on the final state x(τ) but also on the middle state, it is possible to calculate the gradients by performing the error backward propagation in a similar manner.

### Second Example

In the above method, since the calculation graph in the forward propagation is stored in the storage 12 for performing the backward propagation of the ordinary differential equation, a large memory is required. In order to prevent this, a method of Neural ODE (Ordinary Differential Equations) may be used.

According to this method, the calculation of forward propagation and backward propagation is executed based on the equation (7). When executing the forward propagation, the equation (7) is calculated in the forward direction, and when executing the backward propagation, a differential equation for calculating a gradient with respect a loss is prepared and integration is performed in a reverse direction. By performing the calculation as above, it becomes possible to execute each of the calculation in the forward direction and the calculation in the reverse direction, in an independent manner.

In the generation of physical model, a loss L is defined as in an equation (11), and an optimization of minimizing the loss is executed.

L_{ODE}(x(t1))=L_{ODE}(∫ₜ₀^{t1}(x(t);θ,t)dt) (eq. 11)

By defining, with respect to this loss, a as in an equation (12), it becomes possible to execute the calculation in the reverse direction regarding time in accordance with an equation (13), without using the data of the calculation graph described above, namely, without storing the data of the calculation graph in the storage 12.

$$\begin{matrix}a ( t ) = \frac{\partial {L}_{ODE}}{\partial x ( t )} & ( eq . 12 ) \\ \frac{da ( t )}{dt} = - {a ( t )}^{T} \frac{\partial f ( x ( t ) ; θ , t )}{\partial x} & ( eq . 13 ) \\ {a}_{θ} ( t ) = \frac{\partial {L}_{ODE}}{\partial θ} & ( eq . 14 ) \\ \frac{{da}_{θ} ( t )}{dt} = - {a ( t )}^{T} \frac{\partial f ( x ( t ) ; θ , t )}{\partial θ} & ( eq . 15 )\end{matrix}$$

Here, the equation (13) and the equation (15) are differential equations for calculating the equation (12) representing the gradient of the loss function L_{ODE} by the state x(t) and the equation (14) representing the gradient of the loss function L_{ODE} by the parameter θ, respectively, and the equations are set up simultaneously with the equation (5), to thereby execute the integration by a proper differential equation solver in a direction from t1 to t0. This processing makes it possible to acquire a differential ∂L_{ODE}/∂x(t0) of L_{ODE} by the initial state and a differential ∂L_{ODE}/∂θ of L_{ODE} by the parameter.

### Third Example

In the above-described method of using Neural ODE, it is possible to greatly reduce the data stored in the storage 12, when compared to a case of storing the calculation graph of the forward propagation. On the other hand, regarding the calculation in the reverse direction, since a is calculated in reverse chronological order, the calculation is sometimes performed in a numerically unstable manner, and thus it is not always possible to perform proper calculation. For example, if, in a case where a phenomenon toward a steady state occurs in a calculation in a forward direction, a calculation in a reverse direction is performed at the same point, a problem such as solution divergence may occur. Accordingly, in the example to be described below, a state obtained through calculation and integration in the forward direction is set to be used in the calculation in the reverse direction, to thereby prevent the divergence.

According to this method, when executing the forward propagation, the equation (7) is calculated in the forward direction. Although the equation (5), the equation (13), and the equation (14) are set up simultaneously to execute the integration by the differential equation solver in the direction from t1 to t0 during the backward propagation in the second example, x(t) calculated by the integration in the equation (5) and used in the integration in the equation (13) and the equation (14) in the above is substituted by x(t) calculated during the forward propagation and stored in the storage 12. By designing as above, the state x(t) calculated during the forward propagation in which the divergence does not occur, can be used during the backward propagation.

According to the present method, at the timing of calculation in the forward direction, it is only required to store data regarding the state x, without storing data of the calculation graph, and thus it is possible to further improve memory efficiency when compared to that regarding the above-described data of the calculation graph. Besides, the gradients are determined from the time series of θ capable of being acquired as the input data, and the time series of the state x acquired by the forward propagation processing, and thus the calculation which may cause the divergence by being performed in reverse chronological order can be replaced by the calculation during the forward propagation, resulting in that the solution divergence can be suppressed.

### Fourth Example

In the above third example, the time series of the state x from the time point t0 to the time point t1 is stored in the storage 12, but not limited to this. For example, it is also possible that a predetermined time tstep (predetermined step number) is used to store a time series of the state x from a time point t1−tstep to a time point t1 in the storage 12.

In this case, it is possible to execute the backward propagation in accordance with the equation (13) and the equation (15), similarly to the third example, based on a state transition from the time point t1−tstep to the time point t1. When there is a need to perform the backward propagation in reverse chronological order from the time point t1−tstep, the forward propagation processing is executed from the time point t0, thereby calculating a necessary state.

Further, not limited to this, and the state may be stored for each predetermined step (for each predetermined time point) from the time point t0. When data of the state before the time point t1-tstep is required in the backward propagation, the forward propagation may be executed from the latest state among the stored states to execute the backward propagation based on the state obtained through the forward propagation.

As described above, in the present example, a cost for executing the forward propagation may be required, but a consumption of memory can be reduced, when compared to the above-described examples. For this reason, it is possible to regulate the memory consumption while securing the solution stability.

In the explanation here regarding the differential equation and the differential algebraic equation, when the state of x(t0) is given, x(t1) is determined and the differential of L(x(t1)) is determined, but there may be a plurality of times such as t0, t1, and t2. Even when x(t0) is given and the error function depends on states at respective time points such as L(x(t0), x(t1), x(t2)), the differential of L regarding the initial state x(t0) and the parameter θ can be performed in each of the four examples.

In the physical model according to the present embodiment, the forward propagator 140 stores proper data in the storage 12 while executing the forward propagation as described in the respective examples, and the error calculator 142 and the backward propagator 144 execute the backward propagation by executing the error calculation and the gradient calculation in the respective examples.

The updater 146 can update the parameter as follows, regarding an arbitrary time point T during the time points t0 to t1, from a value of the gradient determined as above.

$$θ ( τ ) = θ ( τ ) - ε \cdot \frac{dL}{d θ} \qquad ( eq . 16 )$$

Here, ε can be properly decided in an arbitrary manner.

Further, the method of updating the parameter may not be the above-described method. Any parameter updating method that uses a gradient such as Adam or L-BFGS-B is applicable.

The processing of the forward propagation, the error calculation, the backward propagation, and the parameter update may be repeatedly executed according to need, as indicated by an arrow mark and a dotted arrow mark in FIG. 2. In a case of performing the repetitive arithmetic operation, if ε is reduced, for example, the number of times of repetition of the arithmetic operation is increased but the solution is gradually converged, and if ε is increased to some extent, the speed of convergence in the initial stage is fast but the solution is not always converged to an accurate one. For example, it is possible that ε is increased in the initial stage of arithmetic operation, and is reduced gradually.

The term in which the differential of the function f appears in the equations of the above-described examples, may also be determined by error backward propagation such as one used in a neural network.

As the function f in the equations of the above-described examples, it is possible to select one that performs processing of solving an algebraic equation in the inside thereof. In the differential calculation in this case, a method of Deep Equilibrium Model may be used.

For the calculation of gradient of the differential algebraic equation, it is possible to combine the calculation method in the above-described examples and the method of Deep Equilibrium Model. For example, when numerically solving the differential algebraic equation in the first example, the algebraic equation is numerically solved in the forward propagation in some cases, but in the backward propagation, a calculation according to the following equation based on Deep Equilibrium Model can be used instead of performing the error backward propagation of the calculation of the algebraic equation solver.

$$\frac{dx}{d θ} = - {\frac{\partial f}{\partial x}}^{- 1} \frac{\partial f}{\partial θ} \qquad ( eq . 17 )$$

### Fifth Example

When the system is represented by the algebraic differential equation, the method of calculating the gradient of the error (loss) may also be a method based on the Backward Differentiation Formulae (BDF). Based on the fact that the equation (6) is satisfied for each step, it is possible to come down to a problem of solving an algebraic equation for each step. More concretely, by using a state x at a past predetermined step number s and a parameter θ, an algebraic equation for determining a state at the next step can be approximately generated. For example, the equation (6) regarding the states at the past predetermined step number s and the next step, is rewritten as follows.

g(x(t),x(t−1), . . . ,x(t−s);θ)=0 (eq. 18)

The error gradients dL/dx and dL/dθ are deformed as follows by using g represented by the equation (18).

$$\begin{matrix}\frac{dL}{dx ( t )} = - {\sum }_{k = 1}^{s} \frac{dL}{dx ( t + k )} {( \frac{\partial g}{\partial x ( t + k )} )}^{- 1} \cdot \frac{\partial g}{\partial x ( t )} & ( eq . 19 ) \\ \frac{dL}{d θ ( t )} = - {\sum }_{k = 1}^{s} \frac{dL}{dx ( t + k )} {( \frac{\partial g}{\partial x ( t + k )} )}^{- 1} \cdot \frac{\partial g}{\partial θ ( t )} & ( eq . 20 )\end{matrix}$$

Since it is possible to numerically calculate the error gradients based on the equation (19) and the equation (20), it becomes possible to properly set the parameter for the input state at each step, similarly to the above-described respective examples.

Note that in the above-described backward differentiation formulae, an increment of the step may be arbitrarily set. For example, it may be an increment of a predetermined value or a variable increment.

In the above description, it is set that the BDF is used when the differential equation is implicitly represented as in the equation (6), but not limited to this. For example, also when the differential equation is explicitly represented as in the equation (5), it is possible to acquire error gradients by using the equation (19) and the equation (20), through the equation deformation in a similar manner.

As described above, according to the inferring device 1 according to the present embodiment, when the current state and the future state are input in the device, the device can perform output indicating what kind of control value should be set, for example. By making the physical model to be differentiable, it becomes possible to execute the processing requiring the backward propagation, while properly satisfying requirements regarding both the memory consumption and the stability as described above.

The physical model according to the present embodiment is applicable to, for example, control of a distillation column, an electric circuit, a power station, a factory, a dam, and so on. In the physical model used for the control of these, a state transits along a time axis, but the physical model may also be applied to one other than that being differentiable along the time axis. For example, the physical model can also be applied to a model of particle whose state is decided based on a state of a particle adjacent thereto, or the like. As described above, according to the present embodiment, it becomes possible to form a prediction model with high accuracy and in conformity to the physical law, regarding the physical system represented by the linear or nonlinear differential equation.

Further, the applicable range is not limited to the physical system, and it may be one in which formulation can be performed with a differential equation. For example, the model according to the present embodiment can also be applied to a mathematical model of economy, finance, and the like.

Further, as another application example, the model can also be used for optimization of a measure in reinforcement learning in various kinds of control. It is possible to use the model for optimizing a measure in a manner that the loss L (for example, the equation (2), the equation (11), or the like) in the above description is replaced with a reward, and a gradient of the reward with respect to a parameter is determined.

The trained models of above embodiments may be, for example, a concept that includes a model that has been trained as described and then distilled by a general method.

Some or all of each device (the inferring device 1) in the above embodiment may be configured in hardware, or information processing of software (program) executed by, for example, a CPU (Central Processing Unit), GPU (Graphics Processing Unit). In the case of the information processing of software, software that enables at least some of the functions of each device in the above embodiments may be stored in a non-volatile storage medium (non-volatile computer readable medium) such as CD-ROM (Compact Disc Read Only Memory) or USB (Universal Serial Bus) memory, and the information processing of software may be executed by loading the software into a computer. In addition, the software may also be downloaded through a communication network. Further, entire or a part of the software may be implemented in a circuit such as an ASIC (Application Specific Integrated Circuit) or FPGA (Field Programmable Gate Array), wherein the information processing of the software may be executed by hardware.

A storage medium to store the software may be a removable storage media such as an optical disk, or a fixed type storage medium such as a hard disk, or a memory. The storage medium may be provided inside the computer (a main storage device or an auxiliary storage device) or outside the computer.

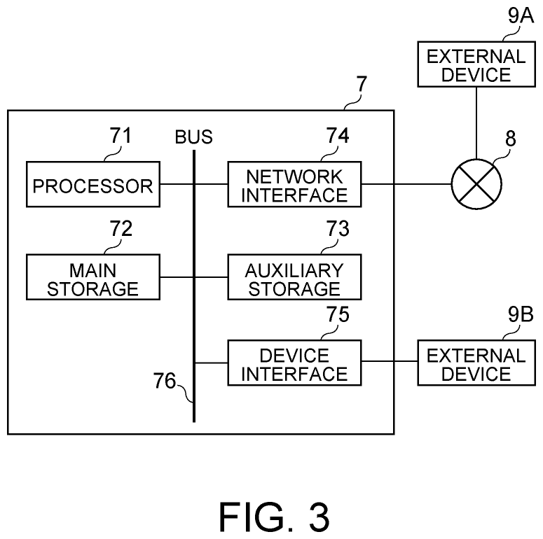

FIG. 3 is a block diagram illustrating an example of a hardware configuration of each device (the inferring device 1) in the above embodiments. As an example, each device may be implemented as a computer 7 provided with a processor 71, a main storage device 72, an auxiliary storage device 73, a network interface 74, and a device interface 75, which are connected via a bus 76.

The computer 7 of FIG. 3 is provided with each component one by one but may be provided with a plurality of the same components. Although one computer 7 is illustrated in FIG. 3, the software may be installed on a plurality of computers, and each of the plurality of computer may execute the same or a different part of the software processing. In this case, it may be in a form of distributed computing where each of the computers communicates with each of the computers through, for example, the network interface 74 to execute the processing. That is, each device (the inferring device 1) in the above embodiments may be configured as a system where one or more computers execute the instructions stored in one or more storages to enable functions. Each device may be configured such that the information transmitted from a terminal is processed by one or more computers provided on a cloud and results of the processing are transmitted to the terminal.

Various arithmetic operations of each device (the inferring device 1) in the above embodiments may be executed in parallel processing using one or more processors or using a plurality of computers over a network. The various arithmetic operations may be allocated to a plurality of arithmetic cores in the processor and executed in parallel processing. Some or all the processes, means, or the like of the present disclosure may be implemented by at least one of the processors or the storage devices provided on a cloud that can communicate with the computer 7 via a network. Thus, each device in the above embodiments may be in a form of parallel computing by one or more computers.

The processor 71 may be an electronic circuit (such as, for example, a processor, processing circuitry, processing circuitry, CPU, GPU, FPGA, or ASIC) that executes at least controlling the computer or arithmetic calculations. The processor 71 may also be, for example, a general-purpose processing circuit, a dedicated processing circuit designed to perform specific operations, or a semiconductor device which includes both the general-purpose processing circuit and the dedicated processing circuit. Further, the processor 71 may also include, for example, an optical circuit or an arithmetic function based on quantum computing.

The processor 71 may execute an arithmetic processing based on data and/or a software input from, for example, each device of the internal configuration of the computer 7, and may output an arithmetic result and a control signal, for example, to each device. The processor 71 may control each component of the computer 7 by executing, for example, an OS (Operating System), or an application of the computer 7.

Each device (the inferring device 1) in the above embodiments may be enabled by one or more processors 71. The processor 71 may refer to one or more electronic circuits located on one chip, or one or more electronic circuitries arranged on two or more chips or devices. In the case of a plurality of electronic circuitries are used, each electronic circuit may communicate by wired or wireless.

The main storage device 72 may store, for example, instructions to be executed by the processor 71 or various data, and the information stored in the main storage device 72 may be read out by the processor 71. The auxiliary storage device 73 is a storage device other than the main storage device 72. These storage devices shall mean any electronic component capable of storing electronic information and may be a semiconductor memory. The semiconductor memory may be either a volatile or non-volatile memory. The storage device for storing various data or the like in each device (the inferring device 1) in the above embodiments may be enabled by the main storage device 72 or the auxiliary storage device 73 or may be implemented by a built-in memory built into the processor 71. For example, the storages 12 in the above embodiments may be implemented in the main storage device 72 or the auxiliary storage device 73.

In the case of each device (the inferring device 1) in the above embodiments is configured by at least one storage device (memory) and at least one of a plurality of processors connected/coupled to/with this at least one storage device, at least one of the plurality of processors may be connected to a single storage device. Or at least one of the plurality of storages may be connected to a single processor. Or each device may include a configuration where at least one of the plurality of processors is connected to at least one of the plurality of storage devices. Further, this configuration may be implemented by a storage device and a processor included in a plurality of computers. Moreover, each device may include a configuration where a storage device is integrated with a processor (for example, a cache memory including an L1 cache or an L2 cache).

The network interface 74 is an interface for connecting to a communication network 8 by wireless or wired. The network interface 74 may be an appropriate interface such as an interface compatible with existing communication standards. With the network interface 74, information may be exchanged with an external device 9A connected via the communication network 8. Note that the communication network 8 may be, for example, configured as WAN (Wide Area Network), LAN (Local Area Network), or PAN (Personal Area Network), or a combination of thereof, and may be such that information can be exchanged between the computer 7 and the external device 9A. The internet is an example of WAN, IEEE802.11 or Ethernet (registered trademark) is an example of LAN, and Bluetooth (registered trademark) or NFC (Near Field Communication) is an example of PAN.

The device interface 75 is an interface such as, for example, a USB that directly connects to the external device 9B.

The external device 9A is a device connected to the computer 7 via a network. The external device 9B is a device directly connected to the computer 7.

The external device 9A or the external device 9B may be, as an example, an input device. The input device is, for example, a device such as a camera, a microphone, a motion capture, at least one of various sensors, a keyboard, a mouse, or a touch panel, and gives the acquired information to the computer 7. Further, it may be a device including an input unit such as a personal computer, a tablet terminal, or a smartphone, which may have an input unit, a memory, and a processor.

The external device 9A or the external device 9B may be, as an example, an output device. The output device may be, for example, a display device such as, for example, an LCD (Liquid Crystal Display), or an organic EL (Electro Luminescence) panel, or a speaker which outputs audio. Moreover, it may be a device including an output unit such as, for example, a personal computer, a tablet terminal, or a smartphone, which may have an output unit, a memory, and a processor.

Further, the external device 9A or the external device 9B may be a storage device (memory). The external device 9A may be, for example, a network storage device, and the external device 9B may be, for example, an HDD storage.

Furthermore, the external device 9A or the external device 9B may be a device that has at least one function of the configuration element of each device (the inferring device 1) in the above embodiments. That is, the computer 7 may transmit a part of or all of processing results to the external device 9A or the external device 9B, or receive a part of or all of processing results from the external device 9A or the external device 9B.

In the present specification (including the claims), the representation (including similar expressions) of “at least one of a, b, and c” or “at least one of a, b, or c” includes any combinations of a, b, c, a-b, a-c, b-c, and a-b-c. It also covers combinations with multiple instances of any element such as, for example, a-a, a-b-b, or a-a-b-b-c-c. It further covers, for example, adding another element d beyond a, b, and/or c, such that a-b-c-d

In the present specification (including the claims), the expressions such as, for example, “data as input,” “using data,” “based on data,” “according to data,” or “in accordance with data” (including similar expressions) are used, unless otherwise specified, this includes cases where data itself is used, or the cases where data is processed in some ways (for example, noise added data, normalized data, feature quantities extracted from the data, or intermediate representation of the data) are used. When it is stated that some results can be obtained “by inputting data,” “by using data,” “based on data,” “according to data,” “in accordance with data” (including similar expressions), unless otherwise specified, this may include cases where the result is obtained based only on the data, and may also include cases where the result is obtained by being affected factors, conditions, and/or states, or the like by other data than the data. When it is stated that “output/outputting data” (including similar expressions), unless otherwise specified, this also includes cases where the data itself is used as output, or the cases where the data is processed in some ways (for example, the data added noise, the data normalized, feature quantity extracted from the data, or intermediate representation of the data) is used as the output.

In the present specification (including the claims), when the terms such as “connected (connection)” and “coupled (coupling)” are used, they are intended as non-limiting terms that include any of “direct connection/coupling,” “indirect connection/coupling,” “electrically connection/coupling,” “communicatively connection/coupling,” “operatively connection/coupling,” “physically connection/coupling,” or the like. The terms should be interpreted accordingly, depending on the context in which they are used, but any forms of connection/coupling that are not intentionally or naturally excluded should be construed as included in the terms and interpreted in a non-exclusive manner.

In the present specification (including the claims), when the expression such as “A configured to B,” this may include that a physically structure of A has a configuration that can execute operation B, as well as a permanent or a temporary setting/configuration of element A is configured/set to actually execute operation B. For example, when the element A is a general-purpose processor, the processor may have a hardware configuration capable of executing the operation B and may be configured to actually execute the operation B by setting the permanent or the temporary program (instructions). Moreover, when the element A is a dedicated processor, a dedicated arithmetic circuit, or the like, a circuit structure of the processor or the like may be implemented to actually execute the operation B, irrespective of whether or not control instructions and data are actually attached thereto.

In the present specification (including the claims), when a term referring to inclusion or possession (for example, “comprising/including,” “having,” or the like) is used, it is intended as an open-ended term, including the case of inclusion or possession an object other than the object indicated by the object of the term. If the object of these terms implying inclusion or possession is an expression that does not specify a quantity or suggests a singular number (an expression with a or an article), the expression should be construed as not being limited to a specific number.

In the present specification (including the claims), although when the expression such as “one or more,” “at least one,” or the like is used in some places, and the expression that does not specify a quantity or suggests a singular number (the expression with a or an article) is used elsewhere, it is not intended that this expression means “one.” In general, the expression that does not specify a quantity or suggests a singular number (the expression with a or an as article) should be interpreted as not necessarily limited to a specific number.

In the present specification, when it is stated that a particular configuration of an example results in a particular effect (advantage/result), unless there are some other reasons, it should be understood that the effect is also obtained for one or more other embodiments having the configuration. However, it should be understood that the presence or absence of such an effect generally depends on various factors, conditions, and/or states, etc., and that such an effect is not always achieved by the configuration. The effect is merely achieved by the configuration in the embodiments when various factors, conditions, and/or states, etc., are met, but the effect is not always obtained in the claimed invention that defines the configuration or a similar configuration.

In the present specification (including the claims), when the term such as “maximize/maximization” is used, this includes finding a global maximum value, finding an approximate value of the global maximum value, finding a local maximum value, and finding an approximate value of the local maximum value, should be interpreted as appropriate accordingly depending on the context in which the term is used. It also includes finding on the approximated value of these maximum values probabilistically or heuristically. Similarly, when the term such as “minimize” is used, this includes finding a global minimum value, finding an approximated value of the global minimum value, finding a local minimum value, and finding an approximated value of the local minimum value, and should be interpreted as appropriate accordingly depending on the context in which the term is used. It also includes finding the approximated value of these minimum values probabilistically or heuristically. Similarly, when the term such as “optimize” is used, this includes finding a global optimum value, finding an approximated value of the global optimum value, finding a local optimum value, and finding an approximated value of the local optimum value, and should be interpreted as appropriate accordingly depending on the context in which the term is used. It also includes finding the approximated value of these optimal values probabilistically or heuristically.

In the present specification (including claims), when a plurality of hardware performs a predetermined process, the respective hardware may cooperate to perform the predetermined process, or some hardware may perform all the predetermined process. Further, a part of the hardware may perform a part of the predetermined process, and the other hardware may perform the rest of the predetermined process. In the present specification (including claims), when an expression (including similar expressions) such as “one or more hardware perform a first process and the one or more hardware perform a second process,” or the like, is used, the hardware that perform the first process and the hardware that perform the second process may be the same hardware, or may be the different hardware. That is: the hardware that perform the first process and the hardware that perform the second process may be included in the one or more hardware. Note that, the hardware may include an electronic circuit, a device including the electronic circuit, or the like.

In the present specification (including the claims), when a plurality of storage devices (memories) store data, an individual storage device among the plurality of storage devices may store only a part of the data or may store the entire data. Further, some storage devices among the plurality of storage devices may include a configuration for storing data.

While certain embodiments of the present disclosure have been described in detail above, the present disclosure is not limited to the individual embodiments described above. Various additions, changes, substitutions, partial deletions, etc. are possible to the extent that they do not deviate from the conceptual idea and purpose of the present disclosure derived from the contents specified in the claims and their equivalents. For example, when numerical values or mathematical formulas are used in the description in the above-described embodiments, they are shown for illustrative purposes only and do not limit the scope of the present disclosure. Further, the order of each operation shown in the embodiments is also an example, and does not limit the scope of the present disclosure.

1. An inferring device comprising:
one or more memories; and
one or more processors configured to:
input input data including at least information regarding a first state in a differentiable physical model to calculate an inferred second state; and
infer, based on a second state and the inferred second state, a parameter that transits from the first state to the second state.

2. The inferring device according to claim 1, wherein
the input data includes information regarding a parameter.

3. The inferring device according to claim 2, wherein
the one or more processors are configured to perform error backward propagation on the differentiable physical model by using an error between the second state and the inferred second state, to infer the parameter that transits from the first state to the second state.

4. The inferring device according to claim 2, wherein
the one or more processors are configured to execute the error backward propagation and update the parameter by using a gradient based on the differentiable physical model, to infer the parameter that transits from the first state to the second state.

5. The inferring device according to claim 4, wherein
the one or more processors are configured to:
store an interim process of arithmetic operation in the one or more memories; and
execute the error backward propagation by using the stored interim process.

6. The inferring device according to claim 1, wherein
the differentiable physical model is a model generated based on a method of Neural ODE (Ordinary Differential Equations).

7. The inferring device according to claim 4, wherein
the one or more processors are configured to:
store data of a transition state of the first state in the one or more memories; and
execute the error backward propagation by using the transition state.

8. The inferring device according to claim 7, wherein
the one or more processors are configured to store data of the transition state from the first state to the second state in the one or more memories.

9. The inferring device according to claim 7, wherein
the one or more processors are configured to store data at a predetermined step, out of data of the transition state from the first state to the second state, in the one or more memories.

10. The inferring device according to claim 1, wherein
the differentiable physical model is a differential equation solver that determines a solution of a physical system represented by a differential equation.

11. The inferring device according to claim 1, wherein the first state, the second state, and the inferred second state are a state of a control target device respectively,
the parameter includes information regarding at least one of a control of the control target device, or environment of the control target device.

12. The inferring device according to claim 11, wherein the state of control target device includes information regarding substance existing inside the control target device.

13. The inferring device according to claim 11, wherein the information regarding substance includes information regarding at least one of amount of the substance, or internal energy of the substance.

14. The inferring device according to claim 11, wherein the parameter includes information regarding at least one of a temperature, a humidity, a pressure, a voltage, a current, or concentration of substance.

15. The inferring device according to claim 11, wherein the parameter includes information regarding at least one of a volume, a capacity, or a shape of the control target device.

16. The inferring device according to claim 11 wherein the control target device includes a plant.

17. An inferring method comprising:
inputting, by one or more processors, input data including at least information regarding a first state in a differentiable physical model to calculate an inferred second state; and
inferring, by the one or more processor, a parameter that transits from the first state to the second state based on a second state and the inferred second state.

18. The inferring method according to claim 17, wherein the input data includes information regarding a parameter.

19. The inferring method according to claim 18, further comprising:
performing, by the one or more processor, error backward propagation on the differential physical model by using an error between the second state and the inferred second state, to infer the parameter that transits from the first state to the second state.

20. A non-transitory computer readable medium storing a program, the program configured to:
inputting, by one or more processors, input data including at least information regarding a first state in a differentiable physical model to calculate an inferred second state; and
inferring, based on a second state and the inferred second state, a parameter that transits from the first state to the second state.
